(19) United States
(12) Patent Application Publication
(10) Pub. No.: US 2006/0010948 A1
(43) Pub. Date: Jan. 19, 2006

(54) Nitrogen-potash fertiliser and the method for producing thereof

(76) Inventor: Alexander Ivanovich Serebryakov, Moskovskaya obl. (RU)

Correspondence Address: DELLETT & WALTERS, P. O. BOX 82788, PORTLAND, OR, 97282-0788, US

(21) Appl. No.: 10/505,391

(22) PCT Filed: Feb. 17, 2003
(86) PCT No.: PCT/RU03/00050

§ 371 Date: Jul. 25, 2005

(30) Foreign Application Priority Data
Feb. 20, 2002 (RU) 2002104130

(51) Int. Cl. C05G 3/00

(52) U.S. Cl. 71/31; 71/54

(57) ABSTRACT

The invention relates to the composition of nitrogen-potash fertilisers containing carbamide and a potassium-containing component and to the method for the production thereof, and can be used for agriculture and the chemical industry. The inventive nitrogen-potash fertiliser contains carbamide and a potassium-containing component. Said potassium-containing component is embodied in the form of a mixture of potassium sulphate and potassium chloride at the following component ratio: 12-43 mass % of (NH2)2CO in terms of N and 3-40 mass % of a K2SO4 and KCl mixture in terms of K2O. The inventive method for producing a nitrogen-potash fertiliser consists in mixing carbamide in the form of a solution with the mixture of sulphate and potassium chloride. Said invention makes it possible to improve the physico-mechanical and agrochemical properties of the nitrogen-potash fertiliser and extend the range of agricultural crops for the efficient use thereof.

### FIELD OF THE INVENTION

The invention relates to compositions of nitrogen-potash fertilizers containing carbamide and a potassium-containing component as well as to methods of producing them and may be used in the chemical industry and agriculture.

### PRIOR ART

Known in the art is a nitrogen-potash fertilizer in the form of a mixture containing (15-18) % by wt. of carbamide and powdered potassium chloride, which is produced in accordance with a method for producing a nitrogen-potash fertilizer (SU 966087, C 05 D 1/02, 1982). The main disadvantage of the fertilizer is its high water absorbency.

Also known in the art is a nitrogen-potash fertilizer in the form of a mixture containing (10-50) % by wt. of carbamide and/or ammonium nitrate and potassium chloride, which is produced in accordance with a method for producing granulated nitrogen-potash fertilizers (FR 1476296, C 05 D 1/02, 1966). In a case of using carbamide the nitrogen content is (4.6-23) % by wt. The main disadvantage of the fertilizer is a small quantity of nitrogen as a nutrient and, moreover, granules have irregular volumetric composition.

Known is a nitrogen-potash fertilizer in the form of a mixture of substandard components, namely, (35-90) % by wt. of carbamide and potassium chloride. In particular, as carbamide a powdered semi-finished product is used, which is formed in the production of carbamide after separating the crystallized product from the mother solution, and cyclone dust, taken at the stage of drying and dust removal of flotation potassium chloride, is used as potassium chloride (RU 2100326, C 05 D 1/00, 1997) The main disadvantage of that fertilizer is its poor quality due to presence of impurities undesirable in agriculture, which are present in substandard components, namely NaCl, MgCl₂, MgBr₂, etc.

The second disadvantage is that the granulation stage in the method for producing that fertilizer is not technologically acceptance, since melted fertilizer is poured onto a metal surface where the melt cools down to the form of a thin plate, which is afterwards reduced to granules. The operation results in a big quantity of substandard product.

The closest as to the composition and the properties to this invention is a nitrogen-potash fertilizer containing carbamide and the potassium-containing component in the form of potassium chloride. The ratio of the components (in % by weight) is: (NH₂)₂CO taken as N−(41.4−45.2) and KCl taken as K₂O−(1−5.94) (RU 2154621, C 05 D 1/00, 2000).

The method for producing the said fertilizer includes granulation of a produced mixture of carbamide and potassium chloride in a granulating tower; thus obtained granules are insufficiently robust, in the order of 600 g/granule.

One more disadvantage of the known fertilizer is that it comprises the potassium-containing component in the form of potassium chloride only. Furthermore, the potassium content of that product is low, which reduces its efficiency when being applied, e.g., for tobacco and palm cultures.

### DESCRIPTION OF THE INVENTION

The main technical objective of this invention is to improve the physical-mechanical and agrochemical properties of the nitrogen-potash fertilizer and expand the range of agricultural crops for which it may be efficiently used, as well as to create a method for producing this nitrogen-potash fertilizer.

The stated objective is achieved owing to the fact that in the nitrogen-potash fertilizer, which comprises carbamide and a potassium-containing component, the latter is a mixture of potassium sulfate and potassium chloride at the following ratio of the components (in % by weight): (NH₂)₂CO taken as N−(12−43), a mixture of K₂SO₄ taken as K₂O−(3−40).

Furthermore, the potassium chloride content of the mixture is selected in the range of 0.1-99.9% by weight.

Furthermore, the method of producing the nitrogen-potash fertilizer, including mixing carbamide and a potassium-containing component containing potassium chloride and granulating the obtained pulp, is characterized in that the said potassium-containing component additionally contains potassium sulfate, carbamide is taken in the form of a solution when producing a mixture, and a potassium-containing component is taken in the quantity of 5-67% by weight; further, the obtained pulp is granulated in a granulating drum at a temperature from 100° to 140° C. and the temperature lowering rate of the granulated product along the length of the drum is maintained in the range from 1.9 to 3.8° C./m of the drum length.

The main distinguishing features of the inventive nitrogen-potash fertilizer are that the potassium-containing component is in the form of a mixture of potassium sulfate and potassium chloride at the following ratio of the components (in % by weight): (NH₂)₂CO taken as N−(12−43), a mixture of K₂SO₄ taken as K₂O−(3−40).

An additional distinguishing feature in accordance with this invention is that the potassium chloride content of the mixture is selected in the range from 0.1 to 99.9% by weight.

The main distinguishing feature of the method for producing the inventive nitrogen-potash fertilizer are that carbamide is taken in the form of a solution when producing a mixture, and the potassium-containing component is taken in the quantity of 5-67% by weight, the obtained pulp is granulated in a granulating drum at a temperature from 100° to 140° C. and the temperature lowering rate of the granulated product along the length of the drum is maintained in the range from 1.9 to 3.8°/m of the drum length.

The present invention complies with the patentability criterion “novelty”, since no technical solution has been found in the prior art, which essential features would fully coincide with the features contained in the independent claim. No references have been found on a fertilizer comprising carbamide and a mixture of potassium sulfate and potassium chloride, as well as on the method for producing it. This invention also complies with the patentability criterion “inventive step”, since no description of a technical solution is contained in the prior art, which distinctive features would be aimed at solving a technical task at which this invention is aimed.

The essence of the invention will be explained by the following examples:

### EXAMPLE 1

In accordance with this invention carbamide in the form of a 90% carbamide solution is fed to a mixer in the quantity of 26.39 t/h, and a potassium-containing component, being a mixture of potassium sulfate and potassium chloride is fed to the mixer in the quantity of 1.25 t/h, which accounts for 5% by weight of the total quantity of the components in the mixer. The temperature of the potassium-containing component is from 60° to 70° C. The potassium chloride content of the potassium-containing components mixture is 99.9% by weight. Then the pulp is fed to granulation in a granulating drum having 4.5 m in diameter and 16 m in length. The speed of the granulating drum is 4.2 revolutions per minute. The temperature in the granulation zone is 135° C. The granulated product exiting the drum has the temperature from 70° to 75° C. and contains N—43.0% by weight, K₂O—3.0% by weight, H₂O—0.2% by weight. The biuret content is 0.7% by weight. The finished product exiting the granulating drum has the following gradation: 1-4 mm fraction—at least 90%, less than 1 mm fraction—up to 3%, more than 6 mm fraction—nil. The granule strength is 1200 g/granule. The average finished product output is 25 t/h. The temperature lowering rate of the granulated product along the length of the drum is 3.8° per 1 meter of the drum length.

### EXAMPLE 2

The process is the same as in Example 1, but has the following differences.

Carbamide in the form of a 90% carbamide solution is fed to a mixer in the quantity of 9.17 t/h, and a potassium-containing component, being a mixture of potassium sulfate and potassium chloride is fed to the mixer in the quantity of 16.75 t/h, which accounts for 67% by weight of the total quantity of the components in the mixer. The potassium sulfate content of the potassium-containing components mixture is 99.9% by weight. The temperature in the granulation zone was 101° C. The granulated product exiting the drum contains N—15.18% by weight, K₂O—33.5% by weight. The temperature lowering rate of the granulated product along the length of the drum, when producing the fertilizer with the said composition, is taken as 1.9° per 1 meter of the drum length.

### EXAMPLE 3

The process is the same as in Example 1, but has the following differences.

Carbamide in the form of a 90% carbamide solution is fed to a mixer in the quantity of 13.9 t/h, and a potassium-containing component, being a mixture of potassium sulfate and potassium chloride, is fed to the mixer in the quantity of 12.5 t/h, which accounts for 50% by weight of the total quantity of the components in the mixer. The potassium sulfate and potassium chloride content of the mixture is 50.0% each by weight. The temperature in the granulation zone is maintained at 105° C. The granulated product exiting the drum contains N—23.0% by weight, K₂O—27.5% by weight. The granule strength is 1190 g/granule. The biuret content is 0.69% by weight. The temperature lowering rate of the granulated product along the length of the drum is taken as 2.2° per 1 meter of the drum length.

### EXAMPLE 4

The process is the same as in Example 1, but has the following differences.

Carbamide in the form of a 90% carbamide solution is fed to a mixer in the quantity of 8.33 t/h, and a potassium-containing component, being a mixture of potassium sulfate and potassium chloride, is fed to the mixer in the quantity of 17.5 t/h, which accounts for 70% by weight of the total quantity of the components in the mixer. The potassium chloride content of the potassium-containing components mixture is 99.9% by weight. The temperature in the granulation zone is maintained at 138° C. The granulated product exiting the drum contains N—13.8% by weight, K₂O—41.99% by weight. The granule strength is 1220 g/granule. The biuret content is 0.91% by weight. The temperature lowering rate of the granulated product along the length of the drum is taken as 4.1° per 1 meter of the drum length.

### EXAMPLE 5

The process is the same as in Example 1, but has the following differences.

Carbamide in the form of a 90% carbamide solution is fed to a mixer in the quantity of 26.6 t/h, and a potassium-containing component, being a mixture of potassium sulfate and potassium chloride, is fed to the mixer in the quantity of 1.1 t/h, which accounts for 4.4% by weight of the total quantity of the components in the mixer. The potassium sulfate and potassium chloride content of the potassium-containing components mixture is 50% each by weight. The temperature in the granulation zone is maintained at 99° C. The granulated product exiting the drum contains N—43% by weight, K₂O—2.42% by weight, H₂O—0.65% by weight. The granule strength is 880 g/granule. The biuret content is 0.9% by weight. The temperature lowering rate of the granulated product along the length of the drum is taken as 1.81° per 1 meter of the drum length.

### EXAMPLE 6

The process is the same as in Example 1, but has the following differences.

Carbamide in the form of a 90% carbamide solution is fed to a mixer in the quantity of 26.4 t/h, and a potassium-containing component, being a mixture of potassium sulfate and potassium chloride, is fed to the mixer in the quantity of 1.25 t/h, which accounts for 5% by weight of the total quantity of the components in the mixer. The potassium sulfate and potassium chloride content of the potassium-containing components mixture is 50% each by weight. The temperature in the granulation zone is maintained at 98° C. The granulated product exiting the drum contains N—43.7% by weight, K₂O —2.75% by weight, H₂O—0.7% by weight. The granule strength is 890 g/granule. The biuret content is 0.9% by weight. The temperature lowering rate of the granulated product along the length of the drum is taken as 1.75° per 1 meter of the drum length.

### EXAMPLE 7

The process is the same as in Example 1, but has the following differences.

Carbamide in the form of a 90% carbamide solution is fed to a mixer in the quantity of 9.17 t/h, and a potassium-containing component, being a mixture of potassium sulfate and potassium chloride, is fed to the mixer in the quantity of 16.75 t/h, which accounts for 67% by weight of the total quantity of the components in the mixer. The potassium sulfate and potassium chloride content of the potassium-containing components mixture is 50% each by weight. The temperature in the granulation zone is maintained at 136° C. The granulated product exiting the drum contains N—15.2% by weight, K₂O —36.85% by weight. The granule strength is 1210 g/granule. The biuret content is 0.7% by weight. The temperature lowering rate of the granulated product along the length of the drum is taken as 3.8° per 1 meter of the drum length.

It should be mentioned that when the upper concentration limit of potassium-containing components mixture was exceeded, which was 41.99% by weight in terms of K₂O (Example 4), and when the granulation zone temperature was increased to 138° C. and the temperature lowering rate of the granulated product along the length of the drum was raised to 4.1° per 1 meter of the drum length, nonstandard fertilizer was obtained, which had a higher K₂O content and a higher biuret content.

When going beyond the lower concentration limit of potassium-containing components mixture, which was from 2.42% to 2.75% by weight in terns of K₂O (Examples 5 and 6), at a lower temperature in the granulation zone (99°−98° C.), and a lower temperature lowering rate of the granulated product along the length of the drum (1.81°−1.75° C. per 1 meter of the drum length), nonstandard fertilizer was obtained also, which had a lower granule strength and a higher biuret and water content.

### INDUSTRIAL APPLICABILITY

This invention is industrially applicable and may be used most successfully in the chemical industry and agriculture for the purpose of producing nitrogen-potash fertilizers having improved physical-mechanical and agrochemical properties.

1. A nitrogen-potash fertilizer comprising carbamide and a potassium-containing component, characterized in that the potassium-containing component is a potassium sulfate and potassium chloride mixture at the following component ratio in weight percent: (NH₂)₂CO in terms of N1—12-43, the mixture of K₂SO₄ and KCl in terms of K₂O—3-40.

2. The nitrogen-potash fertilizer according to claim 1, characterized in that the potassium chloride content of the mixture is taken in the range from 0.1 to 99.9 weight percent.

3. A method for producing the nitrogen-potash fertilizer claimed in claim 1, including mixing carbamide and a potassium-containing component containing potassium chloride and granulating the obtained pulp, characterized in that the potassium-containing component additionally contains potassium sulfate, carbamide is taken in the form of a solution when producing a mixture, and the potassium-containing component is taken in the quantity of 5-67% by weight; then obtained pulp is granulated in a granulating drum at a temperature from 100° to 140° C. and the temperature lowering rate of the granulated product along the length of the drum is maintained in the range from 1.9 to 3.8° C./m of the drum length.
